(19) United States
(12) Patent Application Publication
(10) Pub. No.: US 2011/0300905 A1
(43) Pub. Date: Dec. 8, 2011

(54) System and Method for Locating an Object Using a Mobile Device

(76) Inventor: Rami Levi, Beverly Hills, CA (US)

(21) Appl. No.: 12/793,697

(22) Filed: Jun. 4, 2010

(51) Int. Cl. H04B 1/38; G08B 13/14; G06K 7/01

(52) U.S. Cl. 455/557; 340/10.1; 340/572.1

(57) ABSTRACT

Disclosed is a system and method for tracking an object using RFID tags in combination with a wireless communication device. A radio frequency module is included for modifying a wireless device to both receive and send RF signals. Typically, the wireless device is a cell phone or smart phone. The module enables the wireless device to read identifying information from an RF signal and displaying such to a user. The system presents an inexpensive method of providing an RFID reader for tracking objects.

### TECHNICAL FIELD

The present invention relates generally to mobile devices for locating an object using radio frequency identification (RFID), and more specifically the invention relates to a method of using a mobile device or wireless communication device modified to receive and interpret a location of an object tagged with an RFID tag.

### BACKGROUND

Presently, bar codes containing a Universal Product Code (“UPC”) have become a nearly ubiquitous feature of modern life. The vast majority of products, as well as packages, containers and other elements in the stream of commerce now bear a bar code to allow for convenient tracking and inventory control.

However, bar codes have some drawbacks. Bar codes are “read only,” in that they are merely a printed set of machine-readable parallel bars that cannot be updated. Bar codes cannot transmit information, but instead must be read by a scanner. Bar codes must be scanned within a relatively short distance and must be properly oriented for the bar code to be read.

“Smart labels,” generally implemented by RFID tags, have been developed in an effort to address the shortcomings of bar codes and add greater functionality. RFID tags have been used to keep track of items such as airline baggage, items of clothing in a retail environment, cows and highway tolls.

Several radio frequency identification (RFID) systems have been developed in recent years to track mobile items like vehicles, products, or animals. RFID systems work by using a transceiver-transponder system. The transceiver (also called an RFID reader) sends out a signal, which activates transponders (also called RFID tags) in the immediate area surrounding the transceiver. The transponders then reply with an encoded message, which is received by the transceiver and interpreted by a computer system connected to the transceiver.

Because each RFID transponder is encoded with unique data or information, items can be uniquely identified and located as they are brought within range and read by a transceiver. For instance, when pallets of products are outfitted with RFID transponders at a manufacturing plant, then shipped to a warehouse on a truck, the truck can simply drive within range of a RFID transceiver as it arrives at the warehouse, and all of the pallets of products that are on the truck are identified immediately upon arrival and added to the warehouse inventory. RFID systems help companies track fleets of vehicles, products throughout the supply chain, and inventory levels at a particular location.

In greater detail, an RFID tag includes a small antenna operatively connected to a microchip. For example, in the UHF band, the tag antenna can be just several inches long and can be implemented with conductive ink or etched in thin metal foil on a substrate of the microchip. Further, each tag can be an active tag powered by a durable power source such as an internal battery, or a passive tag powered by inductive coupling, receiving induced power from RF signals transmitted by an RFID reader. For example, an RFID reader may transmit a continuous unmodulated RF signal (i.e., a continuous wave, CW) or carrier signal for a predetermined minimum period of time to power a passive tag. The volume of space within which a reader can deliver adequate power to a passive tag is known as the power coupling zone of the reader.

The internal battery of active tags may be employed to power integrated environmental sensors, and to maintain data and state information dynamically in an embedded memory of the tag. Because passive tags do not have a durable power source, they do not include active semiconductor circuitry and must maintain data and state information statically within its embedded memory. In addition, passive tags have an essentially unlimited life span, while the life span of active tags is typically limited by the lifetime of the internal battery, which in some implementations may be replaceable.

The RFID tag may be activated by a magnetic field generated by an RFID reader. The tag's antenna picks up the magnetic signal. Conventional RFID tags are passive and are generally configured with a particular surface area for reflecting back the magnetic signal at a particular modulation. That is, RFID tag modulates the signal according to information coded in surface area and reflects the modulated signal back to the RFID reader.

RFID tags use the Electronic Product Code (“EPC” or “ePC”) format for encoding information. An EPC code includes variable length bits of information (common formats are 64, 96 and 128 bits), which allows for identification of individual products as well as associated information. EPC includes header 130, EPC Manager field, Object class field and serial number field. EPC Manager field contains manufacturer information. Object class field includes a product's stock-keeping unit (“SKU”) number. Serial number field is a 40-bit field that can uniquely identify the specific instance of an individual product i.e., not just a make or model, but also down to a specific “serial number” of a make and model.

In general, most existing RFID tags are passive filters that represent a sequence of numbers based on the frequencies they reflect. Each item's RFID tag bounces back a certain frequency that corresponds to the item's identification. Conventional RFID tags have specific patterned surface areas that are designed to reflect specific frequency ranges. Thus, when a reader sweeps within a plurality of different frequency ranges, the reader will receive a reflected signal when a particular RFID tag matches one of the frequency ranges. The obtained reflected signal's particular frequency modulation then corresponds to particular information, such as serial and model number, for a particular RFID tag.

Unfortunately, the implementation of such RFID systems requires a substantial investment in both software and in equipment for both large and small assets. Additionally, users need to invest in such a capital outlay even though they will need such tracking for a short time or for only a portion of their assets.

Thus, what is needed is a system for tracking an object customized to a user's particular needs without the need for extensive capital outlays.

### SUMMARY

The present system and method is for tracking an object using radio frequency identification device (RFID) tags and a wireless communication device. The system further includes a radio frequency receiver (RE) module coupled to a wireless communication device or mobile device for receiving a radio frequency from the tags. The module enables devices like cell phones and smart phones in particular to communicate with and read the information on the tags. The system provides an inexpensive method of providing a REID reader for tracking objects.

In greater detail the system for tracking an object comprises a radio frequency identification tag wherein each RFID tag stores identifying information. The identifying information may be associated with an object tagged including both persons and things. The system further includes an RF receiver module for receiving signals from the RFID tag and for transmitting signals to the RFID tag. The received information comprises identifying information which can be associated with various persons and things. The RF module is coupled to a wireless communication device and transmits the RF signal to the wireless communication device. Additionally, the wireless communication device is adapted to read the RF signal and then displaying the associated identifying information.

The RF receiver module of the present system may be coupled to the communication device via an accessory port located on the device whereby data can be exchanged between the receiver and the device. Additionally, the RF receiver may be attached to the communication device adhesively and including a dedicated power source for powering the RF receiver. When coupled to the communication device's port, the RF receiver module may also include a power source, but typically power is drawn from the device. The module may further include one or more antennae for both receiving and sending signals.

The communication device in a further embodiment may be adapted for geolocation of the RFID tag. Geolocation can be accomplished using either the global positioning system (GPS) or nonGPS systems. The system includes various alarms or alerts that can be preset to indicate when a tagged object strays from a present distance from the communication devices. This embodiment is particularly helpful in the monitoring of children.

The system can include a multitude of tagged objects using a plurality of tags wherein each tag is associated with a specific object. The tags used in the system may be passive, active or combinations of the two.

### DRAWING

In the Drawing:

FIG. 1 depicts the components of the present system including the wireless communication device embodied as a smart phone, the RF module for engagement with the smart phone and the RFID tag which can both send and receive signals to the RF module depending upon the embodiment of the present system for tracking an object.

### DETAILED DESCRIPTION

Disclosed is a system and method for tracking an object using RFID tags in combination with a wireless communication device including an RF module. The RF module modifies a wireless device to function as an RF reader by both receiving and sending RF signals. Typically, the wireless device is a cell phone or smart phone. The module enables the wireless device to read identifying information from received RF signals and displaying such to a user. The system presents an inexpensive method of providing an RFID reader for tracking objects.

### RFID Tag

Typically, there are generally three types of RFID tags: active RFID tags which contain a battery and can transmit signals autonomously; passive RFID tags having no battery and requiring an external source to provoke signal transmission; and battery assisted passive (BAP) RFID tags, requiring an external source to activate but having significant higher forward link capability with greater range. The present system may utilize any one or combinations of the three. Additionally, it is contemplated the system may incorporate RFID tags yet to be developed.

The RFID electronic tag technology is fully compatible with international RFID readers and tag standards making the technology completely universal and transparent in any country or for any class of RFID chip. Currently, these include Class 0, Class 0+, Class 1 and Gen-2 standards. Emerging RFID standards are referred to as Generation 2 or Gen-2 but other standards may emerge and be adopted in the future. The system is compatible with as many standards as possible so that a modified wireless communication device or known also herein in an embodiment as a cell phone RF reader can read any given RFID tag or RFID sensor tag.

In the use of active tags such can be modified to contain sensors such as motion sensors, temperature sensors, and light sensors, so tag data will typically include more than just the tag's ID. Also, the tags can include LEDs and sound emitters. Active tags can also receive commands and send responses to commands. Active tags can be controlled in many ways by commands sent from the modified wireless communication device acting as the RF reader. Of course various other sensors may be added according to the needs of the user.

### Wireless Communication Device

The wireless communication device may be any device capable of interacting with the RF receiver module to turn the combined into an RF reader. The wireless communication device can be in an embodiment a device communicating with a wireless cellular network. In a further embodiment, the wireless communication device is one which is in communication with a non-cellular network such as a WLAN technology network. Example devices include without limitation include in the various embodiments includes smart phones, cellular phones, wireless PDAs and other electronic devices capable of communicating with the RF receiver.

The combined two may be referred to herein as an RF reader. In one embodiment, the wireless communication device may be a cell phone in communication with a cellular network. When in communication with the cellular network the device may communicate with a server providing accumulated reports and in communication with other readers via the server.

When the wireless communication device is a smart phone or other programmable communication device the device may have various system software adaptations programmed into the communication device. The wireless communication device in combination with the module functioning as the reader may communicate with the tags by sending and receiving RF signals.

### RF Receiver Module

The RF receiver module forming one part of the two component RF reader controls RF communications between the RFID tag and the wireless communication device. In an embodiment, the module may include a controller and memory. The controller can include an RFID tag responding to an RFID tag interrogation and read communications.

The RF receiver module may be coupled to the communication device using the device's ports and communicating with the device via such ports. Alternatively, the receiver module may be attached to the device adhesively. The term “adhesively” includes both conventional adhesives and mechanical fasteners such as hook and loop methods and the like. When attached adhesively, the module may communicate with the device wirelessly through such methods as Bluetooth and similar methods and means.

The module can be configured in most any way to communicate with the communication device. The module may have receptor(s) for interfacing with the communication device. Additionally the module may have one or more antennae for interfacing with the RFID tag(s).

### Geolocation

The wireless communication device may be adapted to include in a further embodiment a geolocation processor. Typically, the processor is a software modification added to the communication device but may be in a further embodiment as a hardware or software addition to the RF module. The geolocation processor includes logic to receive data from one or more RFID tags to perform GPS and/or non-GPS geolocation of the RFID tags based on the received data and/or signals.

In GPS based geolocation, location is determined using signals provided to the RF receiver module via geo-stationary satellites. Additionally, the RFID tag may further comprise a sensor as a GPS receiver. The RFID tag then transmits via the RF signal the location of the tag to the RF reader.

In non-GPS based geolocation, location is determined by triangulation based on transmission systems as reference points such as mobile base stations and time to signal calculations. In this manner, cell phone towers can geolocate readers through calculations done by the geolocation processor. Similarly, the readers may be used as a basis to identify the precise location of individual tags by triangulation and synchronization of internal clocks. Since either the location of cell phone towers and/or wireless RF readers is usually known and can include GPS coordinates, precise geolocation of sensors can be achieved using either GPS, non-GPS or hybrid systems.

In a further embodiment, location and movement of the tagged object can be tracked using capture movement directionality (CMD) for passive RFID systems. CMD is defined as a setup of minimum two not completely overlapping Reading Zones (RZ1 and RZ2). Where RZ1 associated with one RF antenna (read point) and RZ2 associated with another RF antenna. Each area can have multiple CMD points that define the perimeter of the area. This setup provides continuity of readings to be able to identify direction of movement of RFID objects.

### Software

Software may also be downloaded directly and transparently into the cell phone or wireless communication device action in combination with the RF module to “train” the wireless device to recognize and analyze a given type of RFID tag. The information may be stored permanently or temporarily in the wireless device.

When the necessary processing and analysis information is downloaded from a remote location, only the ID of the RFID-sensor is necessary, providing a solution for universal sensor analyses for wireless devices such as cell phones. In a further embodiment, hybrid systems can be provided whereby only a basic sensor analysis protocol can be downloaded into the cell phones and the sensor data processing is done remotely. This situation is particularly applicable where complex multivariate analyses of sensor data are required and the cell phone is not a smart phone.

Phones and n particular smart phones may also include in permanent memory a summary table with the necessary IDs to recognize any type of sensor. The above described method allows an ordinary wireless device to instantly become a smart device for any type of sensor.

### Wireless Network Communication

In an embodiment, the RFID tag data can be in communication with a server running software using standard web services over LAN and WAN via the cell phone network. The adapted wireless communication device can communicate and report RFID tag activity via web-services as events that can be handled by server applications.

Of course there can be more than one reader in the system, so that two readers may receive the same transmissions from the same RFID tags, wherein the software can detect and filter the duplicates or report the same to another wireless communication device. Data transmitted within the present system can be done with encryption. The system may send and receive date from and to web services over LAN and WAN. The server in communication with the wireless device maintains a complete history of the tracking data and aggregates the data for consolidated and reported.

### Encoding

The system may further include encoding the RFID tags. The tags can be encoded using the modified wireless communication device or by other means. The system can support by way of example and not limitation may include all 96-bit-based EPC encoding standards such as SGTIN-96, SSCC-96, SGLN-96, GRAI-96 and GIAI-96 for passive tags and TagSense ZT10 and ZT50 for active tags. In the ordering of the based encoding the user's input can be provided by such means as a generated file with encoded data ready to be printed using an RFID printer for passive tags and/or shipment of pre-printed/pre-encoded ready to use tags (passive and active tags).

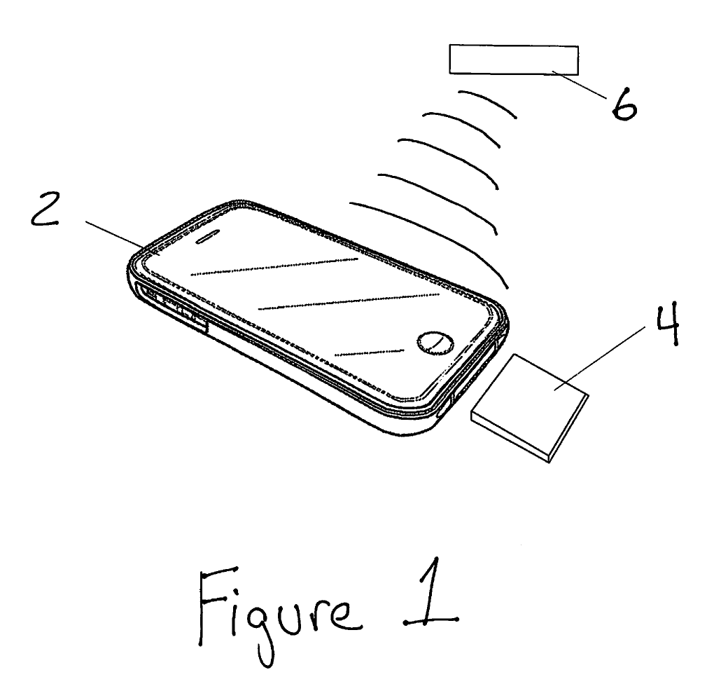

Turning now to FIG. 1 there is illustrated the system and its components. The RFID tag 6 is illustrated as a small rectangle in communication with an RF signal as represented by waves. Of course communication is both from and to the RF receiver module 4 in communication with the wireless communication device 2. The wireless communication device 2 in FIG. 1 is shown as a smart phone. The RF receiver module 4 in the FIGURE is configured to fit within a port of the wireless communication device 2 for communication between the two.

While Applicant has set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A system for tracking an object comprising:
a radio frequency identification (RFID) tag wherein each RFID tag stores a identifying information;
a radio frequency (RF) receiver module for receiving a signal from the RFID tag comprising the identifying information; and
a wireless communication device coupled to the RF receiver module, the communication device adapted to read the received signal and displaying the identifying information.

2. The system of claim 1, wherein the RF receiver module is coupled to the device via an accessory port located on the device whereby data can be exchanged between the receiver and the device.

3. The system of claim 1, wherein the RF receiver module further includes a dedicated power source and is coupled to the device adhesively and the RF receiver module communicates with the device wirelessly.

4. The system of claim 1, wherein the RF receiver module includes an antenna.

5. The system of claim 1, wherein the wireless communication device is a cell phone.

6. The system of claim 1, wherein the RFID tag is an active tag.

7. The system of claim 1, wherein the communication device is adapted for geolocation of the RFID tag.

8. The system of claim 7, further including a proximity alarm wherein the communication device triggers an alert when the REID tag moves outside of a preset distance from the communication device.

9. The system of claim 1, further including the communication device associating an individual tag with a specific object.

10. A system for tracking an object comprising:
a radio frequency identification (RFID) tag wherein each RFID tag stores a identifying information;
a radio frequency (RF) receiver module for receiving a signal from the RFID tag comprising the identifying information; and
a wireless communication device coupled to the RF receiver module, the communication device adapted to read the received signal and displaying the identifying information, and the communication device adapted for geolocation of the RFID tag and triggering an alert when the RFID tag moves outside of a preset distance from the communication device.

11. The system of claim 10, wherein the RF receiver is coupled to the device via an accessory port located on the device whereby data can be exchanged between the receiver and the device.

12. The system of claim 10, wherein the RF receiver module further includes a dedicated power source and is coupled to the device adhesively and the module communicates with the device wirelessly.

13. The system of claim 10, wherein the RF receiver module includes an antenna.

14. The system of claim 10, wherein the wireless communication device is a cell phone.

15. The system of claim 10, wherein the RFID tag is an active tag.

16. A system for tracking an object comprising:
a radio frequency identification (RFID) tag wherein each RFID tag stores a identifying information;
a radio frequency (RF) receiver module for receiving a signal from the RFID tag comprising the identifying information and the receiver including an antenna; and
a cell phone coupled to the RF receiver module via an accessory port located on the device whereby data can be exchanged between the receiver and the device via the port, and the cell phone adapted to read the received signal and displaying the identifying information.

17. The system of claim 16, wherein the cell phone is adapted for geolocation of the RFID tag and triggering an alert when the RFID tag moves outside of a preset distance from the cell phone.

18. The system of claim 16, wherein the RFID tag is an active tag.

19. The system of claim 16, further including the cell phone associating an individual tag with a specific object.

20. The system of claim 16, wherein the RFID tag includes a sensor.
